(19) United States
(12) Patent Application Publication
(10) Pub. No.: US 2025/0058599 A1
(43) Pub. Date: Feb. 20, 2025

(54) STABILIZER BUSH APPARATUS

(71) Applicant: HYUNDAI MOBIS CO., LTD., Seoul (KR)

(72) Inventor: Jung Min KIM, Yongin-si (KR)

(73) Assignee: HYUNDAI MOBIS CO., LTD., Seoul (KR)

(21) Appl. No.: 18/613,667

(22) Filed: Mar. 22, 2024

(30) Foreign Application Priority Data
Aug. 16, 2023 (KR) 10-2023-0106909

(51) Int. Cl. B60G 21/055; B60G 11/20

(52) U.S. Cl. CPC B60G 21/0551; B60G 11/20; B60G 2202/135; B60G 2204/1222; B60G 2204/4104

(57) ABSTRACT

Proposes is a stabilizer bush apparatus including a bracket coupled to a sub-frame, a bearing installed on the bracket, and a bush coupled to the bearing, surrounding a stabilizer bar, and including a sealing portion, the sealing portion being elastically deformed, thereby coming into contact with the bracket and blocking foreign material from being introduced from the outside into the bracket.

### CROSS-REFERENCE TO RELATED APPLICATION

This application claims priority from and the benefit of Korean Patent Application No. 10-2023-0106909, filed on Aug. 16, 2023, which is hereby incorporated by reference for all purposes as if set forth herein.

### BACKGROUND

### Field

Exemplary embodiments relate to a stabilizer bush apparatus, and more particularly, to a stabilizer bush apparatus capable of preventing foreign material from being introduced from the outside thereinto.

### Discussion of the Background

Usually, when a vehicle turns in a circle, the vehicle is inclined because the centrifugal force causes the weight of the vehicle to shift to one side. In order to prevent this phenomenon, a stabilizer bar, which serves as a torsion bar to maintain the balance of the vehicular body, is installed in the vehicle.

The stabilizer bar is fixed using a bush coupled to the vehicular body. The bush serves to absorb the rotation and shock of the stabilizer bar and to prevent noise. However, the occurrence of a gap between the stabilizer bar and the bush may lead to the introduction of foreign material from the outside into the bush. Therefore, there is a need to address this problem.

The related art of the present disclosure is disclosed in Korean Patent Application Publication No. 10-2022-0083317 (published on Jun. 20, 2022 and entitled “STABILIZER BAR BUSH”).

### SUMMARY

Various embodiments, which are contrived to address the above-mentioned problem, are directed to a stabilizing bush apparatus capable of preventing foreign material from being introduced from the outside thereinto.

In an embodiment, a stabilizer bush apparatus includes: a bracket coupled to a sub-frame; a bearing installed on the bracket; and a bush coupled to the bearing, surrounding a stabilizer bar, and including a sealing portion, the sealing portion being elastically deformed, thereby coming into contact with the bracket and blocking foreign material from being introduced from the outside into the bracket.

In an embodiment, in the stabilizer bush apparatus, the bush may include: a bush main body formed of elastic material, coupled to the bearing, and surrounding the stabilizer bar; the sealing portions extending outward in a bent manner from both end portions, respectively, of the bush main body, elastically deformed, thereby coming into contact with the bracket.

In an embodiment, in the stabilizer bush apparatus, the bush may further include an elastic deformation guiding portion guiding the elastic deformation of the sealing portion.

In an embodiment, in the stabilizer bush apparatus, the bush may further include a rigidity reinforcement member coupled to the inside of the bush main body and reinforcing the rigidity of the bush main body.

In an embodiment, in the stabilizer bush apparatus, the bracket may include: a lower bracket coming into contact with the bush; and an upper bracket connected to the lower bracket, thereby being coupled to the sub-frame and coming into contact with the bush.

In an embodiment, in the stabilizer bush apparatus, a hooking groove may be formed in one of the lower and upper brackets, and a hooking protrusion that is hooked into the hooking groove may be formed on the other one of the lower and upper brackets.

In an embodiment, in the stabilizer bush apparatus, the lower bracket may include: a lower bracket main body, one of the following: the hooking groove and the hooking protrusion being formed in or on the lower bracket main body, and first sealing grooves, with which the sealing portion comes into close contact, being formed in both end portions, respectively, of the lower bracket main body; and one or more first foreign-material introduction blocking protrusions formed to protrude inward from the lower bracket main body, and coming into contact with the bush main body.

In an embodiment, in the stabilizer bush apparatus, a plurality of the first foreign-material introduction blocking protrusions may be formed to protrude inward from the lower bracket main body, and may come into contact with the bush main body.

In an embodiment, in the stabilizer bush apparatus, the first sealing grooves each may have an inclined shape in such a manner that a diameter of each increases toward the outside of the lower bracket main body.

In an embodiment, in the stabilizer bush apparatus, the lower bracket main body may include a first mounting groove in which the bearing is mounted, and a first lubrication groove through which a lubricant flows.

In an embodiment, in the stabilizer bush apparatus, the upper bracket may include: an upper bracket main body sliding-coupled to the lower bracket main body, the other one of the following: the hooking groove and the hooking protrusion being formed in or on the upper bracket main body, and second sealing grooves, with which the sealing portion comes into close contact, being formed in both end portions, respectively, of the upper bracket main body; and one or more second foreign-material blocking protrusions formed to protrude inward from the upper bracket main body and coming into contact with the bush main body.

In an embodiment, in the stabilizer bush apparatus, a plurality of the second foreign-material introduction blocking protrusions may be formed to protrude inward from the upper bracket main body, and may come into contact with the bush main body.

In an embodiment, in the stabilizer bush apparatus, the second sealing grooves each may have an inclined shape in such a manner that a diameter of each increases toward the outside of the upper bracket main body.

In an embodiment, in the stabilizer bush apparatus, the upper bracket main body may include a second mounting groove in which the bearing is mounted, and a second lubrication groove which faces the bearing and through which a lubricant flows.

In the stabilizer bush apparatus according to the present disclosure, the bush comes into close contact with the bracket through the sealing portion, thereby blocking foreign material from being introduced from the outside into the bracket. Thus, the effect of preventing damage to the stabilizer bush apparatus due to the introduction of the foreign material can be achieved.

Moreover, according to the present disclosure, the sealing portion of the bush and the first foreign-material introduction blocking protrusion and the second foreign-material blocking protrusion of the bracket can additionally block the foreign material from being introduced into the bush. Thus, the effect of completely blocking the occurrence of the damage to the stabilizer bush apparatus due to the introduction of the foreign material can be achieved.

### BRIEF DESCRIPTION OF THE DRAWINGS

FIG. 1 is a view schematically illustrating a state where a stabilizer bush apparatus according to an embodiment of the present disclosure is coupled to a sub-frame.

FIG. 2 is a perspective view illustrating the stabilizer bush apparatus according to the embodiment of the present disclosure.

FIG. 3 is a cross-sectional perspective view illustrating the stabilizer bush apparatus according to the embodiment of the present disclosure.

FIG. 4 is an enlarged view illustrating essential components, illustrated in FIG. 3, of the stabilizer bush apparatus according to the embodiment of the present disclosure.

FIG. 5 is a cross-sectional view illustrating the stabilizer bush apparatus according to the embodiment of the present disclosure.

FIG. 6 is an exploded perspective view illustrating the stabilizer bush apparatus according to the embodiment of the present disclosure.

FIG. 7 is an exploded perspective view illustrating the stabilizer bush apparatus according to the embodiment of the present disclosure, when viewed from a different direction.

### DETAILED DESCRIPTION OF THE ILLUSTRATED EMBODIMENTS

A stabilizer bush apparatus 1 according to an embodiment of the present disclosure will be described below with reference to the accompanying drawings.

For clarity and convenience in description, thicknesses of lines, sizes of constituent elements, and the like may be illustrated in a non-exact proportion in the drawings. In addition, terms used hereinafter to refer to constituent elements, respectively, according to the present disclosure are defined by considering their respective functions and may be adjusted according to a user's or manager's intentions or to established practices in the art. Therefore, these terms should be contextually defined in light of the present specification.

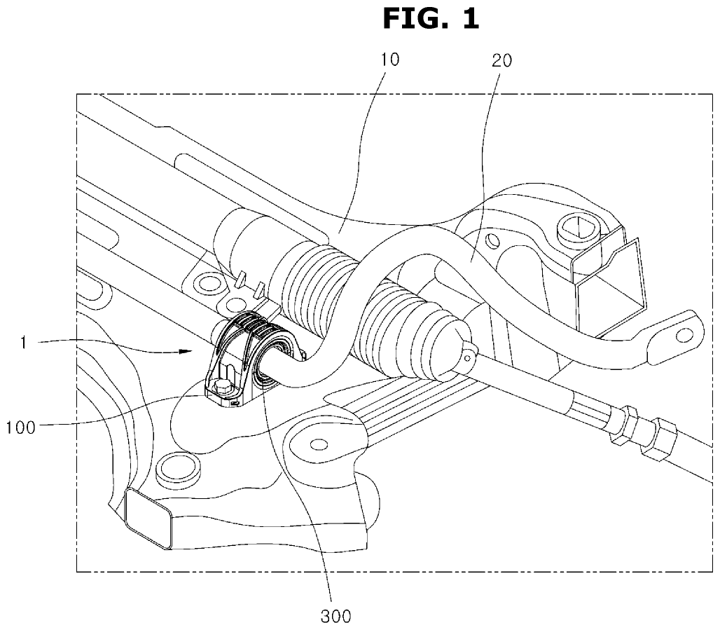

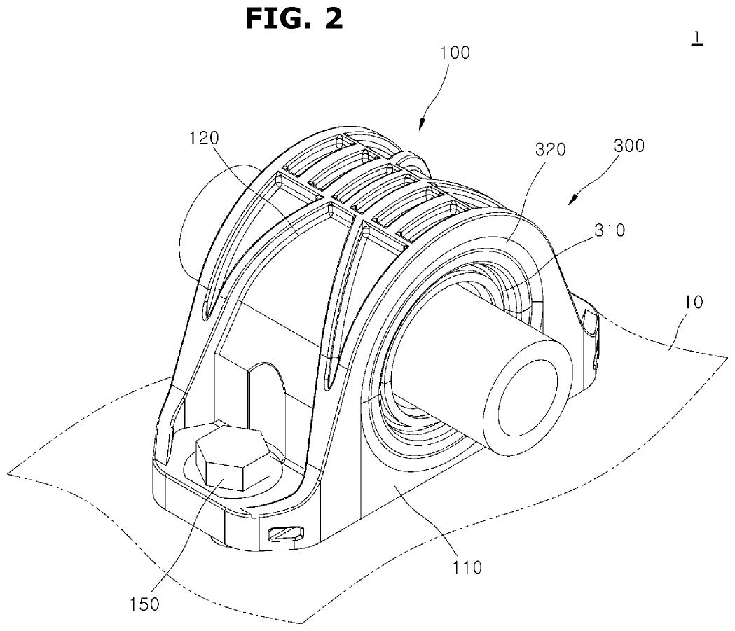

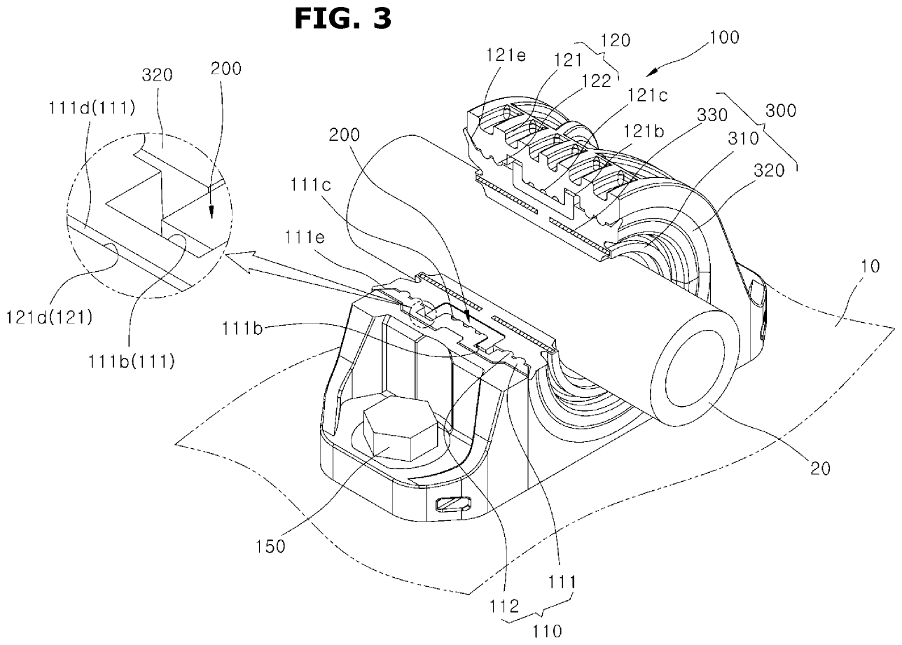

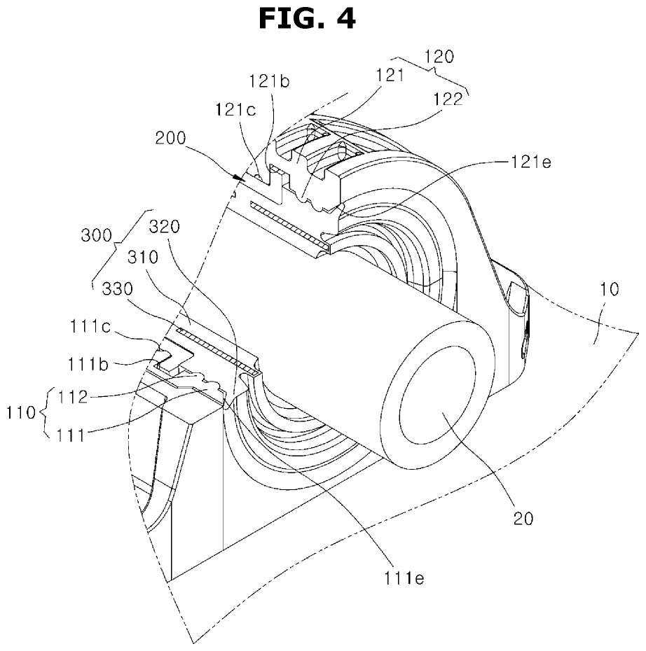

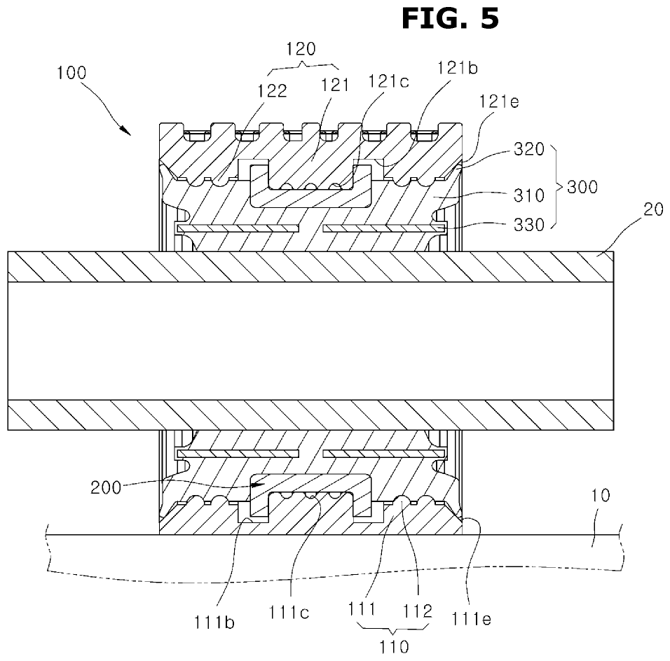

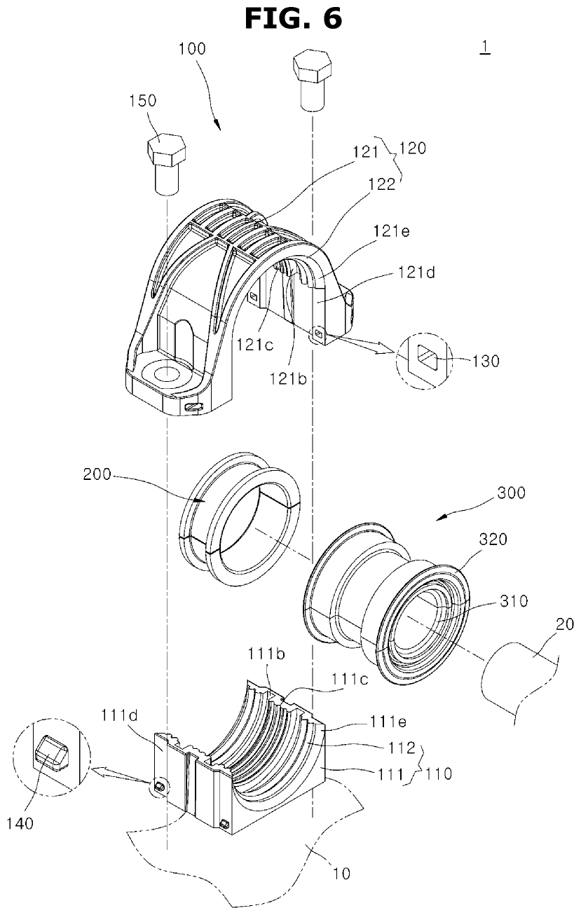

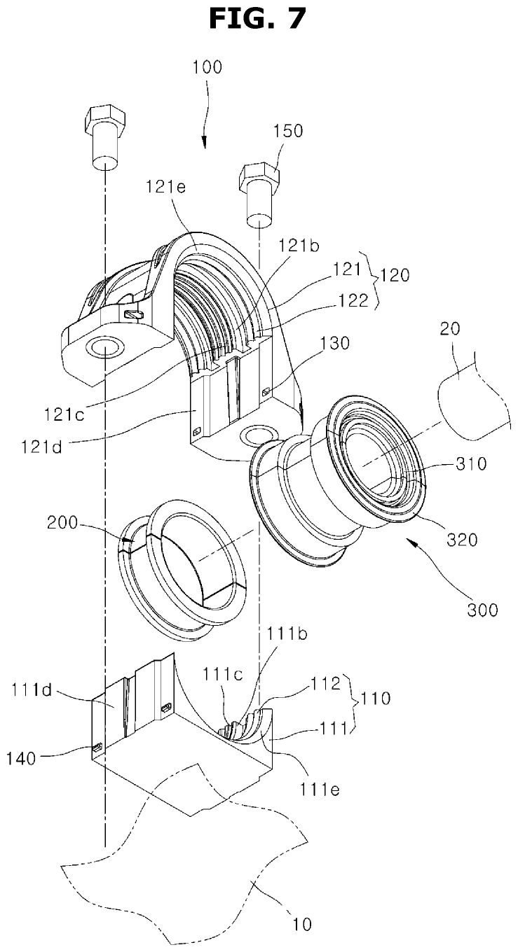

FIG. 1 is a view schematically illustrating a state where the stabilizer bush apparatus 1 according to the embodiment of the present disclosure is coupled to a sub-frame 10. FIG. 2 is a perspective view illustrating the stabilizer bush apparatus 1 according to the embodiment of the present disclosure. FIG. 3 is a cross-sectional perspective view illustrating the stabilizer bush apparatus 1 according to the embodiment of the present disclosure. FIG. 4 is an enlarged view illustrating essential components, illustrated in FIG. 3, of the stabilizer bush apparatus 1 according to the embodiment of the present disclosure. FIG. 5 is a cross-sectional view illustrating the stabilizer bush apparatus 1 according to the embodiment of the present disclosure. FIG. 6 is an exploded perspective view illustrating the stabilizer bush apparatus 1 according to the embodiment of the present disclosure. FIG. 7 is an exploded perspective view illustrating the stabilizer bush apparatus 1 according to the embodiment of the present disclosure, when viewed from a different direction.

With reference to FIGS. 1 to 7, the stabilizer bush apparatus 1 according to the embodiment of the present disclosure includes a bracket 100, a bearing 200, and a bush 300.

The bracket 100 is coupled to the sub-frame 10. The sub-frame 10, as part of a lower portion of a vehicular body, is arranged transversely between vehicular wheels. A stabilizer bar 20 is positioned over the sub-frame 10 (when FIG. 1 is viewed from above) and passes through the bracket 100. The bracket 100 is coupled to the sub-frame 10 (when FIG. 1 is viewed from above) through the bolt unit 150.

The bracket 100 may include a lower bracket 110 and an upper bracket 120 (refer to FIGS. 2 to 5). The lower bracket 110 comes into contact with the bush 300.

The lower bracket 110 may include a lower bracket main body 111 and a first foreign-material introduction blocking protrusion 112. One of the following: a hooking groove 130 and a hooking protrusion 140 may be formed in or on the lower bracket main body 111. The lower bracket main body 111 may have first sealing grooves 111e in both end portions, respectively. Sealing portions 320 of the bush 300 come into close contact with the first sealing grooves 111e, respectively.

The first sealing grooves 111e may be formed in both ends, respectively, of the lower bracket main body 111 and may each have an inclined shape in such a manner that a diameter of each increases toward the outside of the lower bracket main body 111. Thus, the sealing portion 320 of the bush 300 can come into close contact with the first sealing groove 111e, thereby blocking foreign material from being introduced from the outside into the bracket 100.

The lower bracket main body 111 may further include a first mounting groove 111b in which the bearing 200 is mounted, and a first lubrication groove 111c which faces the bearing 200 and through which a lubricant flows.

Accordingly, a portion of one side of the bearing 200 may be readily mounted on the lower bracket main body 111, and the bearing 200 can smoothly operate due to the lubricant flowing between the lower bracket main body 111 and the bearing 200.

The first foreign-material introduction blocking protrusion 112 may be formed in a manner that protruded inward from the lower bracket main body 111, and may come into contact with the bush 300. The first foreign-material introduction blocking protrusion 112 can eliminate a gap between the lower bracket 110 and the bush 300, thereby preventing foreign material from being introduced into the bush 300.

A plurality of the first foreign-material introduction blocking protrusion 112 may be formed on each of both ends of the lower bracket main body 111.

Thus, in a case where, due to damage to the sealing portion 320 of the bush 300 and for other reasons, foreign material is introduced into the lower bracket 110 of the bracket 100, with the first foreign-material introduction blocking protrusion 112, this foreign material can be blocked from being introduced into the bush 300. As a result, the stabilizer bush apparatus 1 can be prevented from being damaged due to the introduction of the foreign material into the bush 300.

The upper bracket 120 can be connected to the lower bracket 110, thereby being coupled to the sub-frame 10 and coming into contact with the bush 300. The upper bracket 120 is temporarily assembled to the lower bracket 110 by being sliding-coupled thereto. In this state, the upper bracket 120 is coupled, with the bolt unit 150, to the sub-frame 10.

The upper bracket 120 may include an upper bracket main body 121 and a second foreign-material blocking protrusion 122. The upper bracket main body 121 is sliding-coupled to the lower bracket main body 111. The other one of the following: the hooking groove 130 and the hooking protrusion 140 is formed in or on the upper bracket main body 121. The upper bracket main body 121 may have second sealing grooves 121e in both end portions, respectively. The sealing portions 320 come into close contact with the second sealing grooves 121e, respectively.

The second sealing grooves 121e may be formed in both end portions, respectively of the upper bracket main body 121 and may each have an inclined shape in such a manner that a diameter of each increases toward the outside of the upper bracket main body 121. Thus, the sealing portion 320 of the bush 300 can come into close contact with the second sealing groove 121e, thereby blocking foreign material from being introduced from the outside into the bracket 100.

The upper bracket main body 121 may further include a second mounting groove 121b in which the bearing 200 is mounted, and a second lubricant groove 121c which faces the bearing 200 and through which the lubricant flows.

Accordingly, a portion of the other side of the bearing 200 may be readily mounted on the upper bracket main body 121, and the bearing 200 can smoothly operate due to the lubricant flowing between the upper bracket main body 121 and the bearing 200.

The second foreign-material blocking protrusion 122 may be formed to protrude inward from the upper bracket main body 121 and may come into contact with the bush 300. The second foreign-material blocking protrusion 122 eliminates a gap between the upper bracket 120 and the bush 300, thereby blocking foreign material from being introduced into the bush 300.

Thus, in a case where, due to damage to the sealing portion 320 of the bush 300 and for other reasons, foreign material is introduced into the upper bracket 120 of the bracket 100, with the second foreign-material introduction blocking protrusion 122, this foreign material can be blocked from being introduced into the bush 300. As a result, the stabilizer bush apparatus 1 can be prevented from being damaged due to the introduction of the foreign material into the bush 300.

The bracket 100 may further include the hooking groove 130 and the hooking protrusion 140 (refer to FIGS. 6 and 7).

The hooking groove 130 may be formed in one of the following: the lower bracket 110 and the upper bracket 120. The hooking protrusion 140 may be protrusively formed on the other one of the following: the lower bracket 110 and the upper bracket 120, and can be coupled to the hooking groove 130.

Specifically, the hooking groove 130 may be formed in the upper bracket main body 121 of the upper bracket 120. In this case, the hooking groove 130 may be formed in a first coupling portion 121d of the upper bracket main body 121.

The hooking protrusion 140 may be protrusively formed on the lower bracket main body 111 of the lower bracket 110. The hooking protrusion 140 may be protrusively formed on a second coupling portion 112d of the lower bracket main body 111 that is sliding-coupled to the first coupling portion 121d of the upper bracket main body 121.

Thus, when the first coupling portion 121d and the second coupling portion 112d are sliding-coupled to each other, the hooking protrusion 140 can be coupled to the hooking groove 130 by being hooked therein.

Since the lower bracket 110 and the upper bracket 120 are hooking-coupled in this manner, the upper bracket 120 can be prevented from deviating from the lower bracket 110.

Moreover, in a state where the lower bracket 110 and the upper bracket 120 are temporarily assembled to each other, the upper bracket 120 can be readily coupled to the sub-frame 10, thereby improving the operating efficiency.

The bracket 100 may further include the bolt unit 150. With the bolt unit 150, the upper bracket 120 can be bolt-coupled to the sub-frame 10. Thus, the bracket 100 can be tightly coupled to the sub-frame 10.

The bearing 200 is installed on the bracket 100. The bearing 200 is arranged between the coupled lower and upper brackets 110 and 120 and the bush 300. Thus, the bearing 200 serves to facilitate rotation of the bush 300 coupled to stabilizer bar 20.

The bush 300 may be coupled to the bearing 200, may surround the stabilizer bar 20, and may include the sealing portion 320. The sealing portion 320 is elastically deformed, thereby coming into contact with the bracket 100 and blocking foreign material from being introduced from the outside into the bracket 100. In this case, the stabilizer bar 20 is coupled to the center portion of the bush 300 in a manner that passes therethrough.

The bush 300 may include a bush main body 310 and the sealing portion 320. The bush main body 310 may be coupled to the bearing 200 and may surround the stabilizer bar 20. The bush main body 310 may be formed of elastic material. The bush main body 310 may be formed, in the shape of a ring, of rubber material. When the stabilizer bar 20 rotates, the bush main body 310 may be elastically deformed.

The bush main body 310 includes an elastic deformation guiding portion 311 that guides the elastic deformation of the sealing portion 320. The elastic deformation guiding portion 311 is a groove in the shape of a ring and is arranged in parallel with the sealing portion 320.

Accordingly, with the elastic deformation guiding portion 311, the sealing portion 320 can be easily elastically deformed, thereby coming into close contact with the first sealing groove 111e and the second sealing groove 121e. The first sealing groove 111e is formed in the lower bracket 110 of the bracket 100. The second sealing groove 121e is formed in the upper bracket main body 121 of the bracket 100.

Thus, a gap between the bracket 100 and the bush 300 can be eliminated, thereby blocking foreign material from being introduced from the outside into the bracket 100. As a result, the stabilizer bush apparatus 1 can be prevented from being damaged due to the foreign material introduced into the bracket 100.

The sealing portions 320 are formed to extend outward in a bent manner from both end portions, respectively, of the bush main body 310. The sealing portions 320 are elastically deformed, thereby coming into contact with the bracket 100 and blocking foreign material from being introduced into the bracket 100.

The sealing portions 320 come into close contact with the first sealing grooves 111e, respectively, formed in both end portions of the lower bracket main body 111, and come into close contact with the second sealing grooves 121e, respectively, formed in both end portions of the upper bracket main body 121. Accordingly, the gap between the bracket 100 and the bush 300 can be eliminated, thereby blocking foreign material from being introduced from the outside into the bracket 100.

The bush 300 may further include a rigidity reinforcement member 330. The rigidity reinforcement member 330 is coupled into the bush main body 310 and reinforces the rigidity of the bush main body 310. The two rigidity reinforcement members 330, as illustrated in FIG. 5, are integrally formed into the bush main body 310 in a manner that ensures horizontal symmetry, thereby supporting the bush main body 310. Thus, the bush main body 310 can maintain a predetermined shape thereof.

As described above, in the stabilizer bush apparatus 1 according to the present disclosure, with the sealing portion 320, the bush 300 comes into close contact with the bracket 100, thereby blocking foreign material from being introduced from the outside into the bracket 100. Thus, the stabilizer bush apparatus 1 can be prevented from being damaged due to the introduction of the foreign material.

In addition, according to the present invention, a double blocking structure is employed. In the double blocking structure, with the sealing portion 320 of the bush 300, the foreign material is primarily blocked from being introduced from the outside into the bracket 100. Furthermore, with the first foreign-material introduction blocking protrusion 112 and the second foreign-material blocking protrusion 122 of the bracket 100, the foreign material introduced into the bracket 100 is secondarily blocked from being introduced into the bush 300. Thus, the stabilizer bush apparatus 1 can be completely prevented from being damaged due to the introduction of the foreign material.

The embodiment of the present disclosure is described only in an exemplary manner with reference to the drawings. It would be apparent to a person of ordinary skill in the art to which the present disclosure pertains that various modifications could be made to the embodiment and that various equivalents thereof could be implemented.

Therefore, the proper technical scope of the present disclosure should be defined by the following claims.

What is claimed is:

1. A stabilizer bush apparatus comprising:
a bracket coupled to a sub-frame;
a bearing installed on the bracket; and
a bush coupled to the bearing, surrounding a stabilizer bar, and including a sealing portion,
wherein the sealing portion is configured to be elastically deformed to be contact with the bracket.

2. The stabilizer bush apparatus of claim 1, wherein the bush comprises:
a bush main body including an elastic material, coupled to the bearing, and surrounding the stabilizer bar; and
the sealing portions extending outward in a bent manner from both end portions, respectively, of the bush main body, elastically deformed to be into contact with the bracket.

3. The stabilizer bush apparatus of claim 2, wherein the bush further comprises:
an elastic deformation guiding portion guiding the elastic deformation of the sealing portion.

4. The stabilizer bush apparatus of claim 2, wherein the bush further comprises:
a rigidity reinforcement member coupled to the inside of the bush main body and reinforcing rigidity of the bush main body.

5. The stabilizer bush apparatus of claim 2, wherein the bracket comprises:
a lower bracket being in contact with the bush; and
an upper bracket connected to the lower bracket to be coupled to the sub-frame and to be contact with the bush.

6. The stabilizer bush apparatus of claim 5, wherein a hooking groove is disposed in one of the lower and upper brackets, and a hooking protrusion that is hooked into the hooking groove is disposed on the other one of the lower and upper brackets.

7. The stabilizer bush apparatus of claim 6, wherein the lower bracket comprises:
a lower bracket main body, one of the following: the hooking groove and the hooking protrusion being disposed in or on the lower bracket main body, and first sealing grooves, which the sealing portion is contact with, being disposed in both end portions, respectively, of the lower bracket main body; and
one or more first foreign-material introduction blocking protrusions protruding inward from the lower bracket main body, and being in contact with the bush main body.

8. The stabilizer bush apparatus of claim 7, wherein a plurality of the first foreign-material introduction blocking protrusions protrude inward from the lower bracket main body, and are in contact with the bush main body.

9. The stabilizer bush apparatus of claim 7, wherein the first sealing grooves each have an inclined shape in such a manner that a diameter of each increases toward the outside of the lower bracket main body.

10. The stabilizer bush apparatus of claim 7, wherein the lower bracket main body includes a first mounting groove in which the bearing is mounted, and a first lubrication groove through which a lubricant flows.

11. The stabilizer bush apparatus of claim 7, wherein the upper bracket comprises:
an upper bracket main body sliding-coupled to the lower bracket main body, the other one of the following: the hooking groove and the hooking protrusion being disposed in or on the upper bracket main body, and second sealing grooves, which the sealing portion are in contact with, being disposed in both end portions, respectively, of the upper bracket main body; and
one or more second foreign-material blocking protrusions protruding inward from the upper bracket main body and being in contact with the bush main body.

12. The stabilizer bush apparatus of claim 11, wherein a plurality of the second foreign-material introduction blocking protrusions protrude inward from the upper bracket main body, and are in contact with the bush main body.

13. The stabilizer bush apparatus of claim 11, wherein the second sealing grooves each have an inclined shape in such a manner that a diameter of each increases toward the outside of the upper bracket main body.

14. The stabilizer bush apparatus of claim 11, wherein the upper bracket main body includes a second mounting groove in which the bearing is mounted, and a second lubrication groove which faces the bearing and through which a lubricant flows.

15. The stabilizer bush apparatus of claim 1, wherein the sealing portion is contact with the bracket to block a foreign material from being introduced from the outside into the bracket.
